(19) United States
(12) Patent Application Publication
(10) Pub. No.: US 2025/0202268 A1
(43) Pub. Date: Jun. 19, 2025

(54) FUEL CELL SYSTEM

(71) Applicant: JTEKT CORPORATION, Kariya-shi (JP)

(72) Inventors: Motoo NAKAI, Nara (JP); Tatsuma KOUCHI, Osaka (JP); Ayumi NAKASONE, Aichi (JP)

(73) Assignee: JTEKT CORPORATION, Kariya-shi (JP)

(21) Appl. No.: 18/833,991

(22) PCT Filed: Feb. 23, 2022
(86) PCT No.: PCT/JP2022/007436

§ 371 Date: Jul. 29, 2024

(51) Int. Cl. H02J 7/34; H01M 8/04303; H01M 8/04746; H01M 8/04858

(52) U.S. Cl. CPC H02J 7/34; H01M 8/04303; H01M 8/04753; H01M 8/04873; H02J 2300/30

(57) ABSTRACT

A fuel cell system includes a fuel cell, a control device, an auxiliary power source serving as a first power storage device, and a receiving power storage device serving as a second power storage device. Under control of the control device, power output from the fuel cell is supplied to an external load and is also charged to the auxiliary power source, in a state in which supply of liquid fuel to the fuel cell is being carried out. Further, in addition to the power output from the fuel cell, post-stoppage power recovered by the receiving power storage device is discharged and supplied to the external load. Power charged in the auxiliary power source is discharged and supplied to the external load in a state in which supply of liquid fuel to the fuel cell is stopped.

### TECHNICAL FIELD

The present disclosure relates to a fuel cell system.

### BACKGROUND ART

Fuel cells which are the main components of a fuel cell system, and fuel cell of a solid polymer types in particular, generally have an electrode structure made up of an anode electrode formed on one face side of an electrolyte membrane and a cathode electrode formed on the other face side. In a fuel cell of a solid polymer type, a fuel is supplied to the anode electrode and also an oxidant is externally supplied to the cathode electrode, causing an electrode reaction in the electrode structure to generate power.

In recent years, direct-type fuel cells have been developed that directly use liquid fuel such as methanol, formic acid, or the like, as the fuel supplied to the anode electrode. In a case of using liquid fuel, handling is easier and energy density per unit volume is higher as compared to using gaseous fuels such as hydrogen gas or the like, which is extremely useful.

In such a direct-type fuel cell, there are cases of a phenomenon occurring in which output power from power generation gradually decreases in a situation in which the fuel cell is continuously operated to generate power. In order to suppress decrease in output power and maintain the output power, refresh control is executed in direct-type fuel cells, to periodically stop the electrode reaction. In a case in which refresh control is executed, the electrode reaction in the direct-type fuel cell is temporarily stopped, which is to say that power generation is stopped, and accordingly output power becomes unstable.

As a conventional configuration for stabilizing the output power, for example, Patent Document 1 discloses a configuration of a fuel cell system that includes an auxiliary power source that is charged with power generated by a fuel cell. In the configuration disclosed in Patent Document 1, the fuel cell externally outputs power and also charges the auxiliary power source, and in a situation in which output power of the fuel cell decreases, the power charged (stored) in the auxiliary power source is discharged, thereby stabilizing the power that is externally output.

### RELATED ART DOCUMENTS

### Patent Documents

Patent Document 1: Japanese Unexamined Patent Application Publication No. 2007-280741 (JP 2007-280741 A)

### BRIEF SUMMARY

Now, in a fuel cell system equipped with a direct-type liquid fuel cell, in a case of executing refresh control on the fuel cell, supply of liquid fuel to an anode electrode of the fuel cell is usually stopped. In this case, in an electrode structure, power generation by electrode reaction using the liquid fuel that has already been supplied continues, after which the electrode reaction stops.

Accordingly, in a case in which it takes time for the liquid fuel that has already been supplied to be consumed by the electrode reaction in the electrode structure, the time during which the fuel cell stops generating power to externally output power will be longer in accordance with the refresh control being executed. As a result, even when power charged to an auxiliary power source is supplied, the power that is externally output becomes unstable. Accordingly, from a perspective of stabilizing external power output, the time during which power generation by the fuel cell is stopped due to the refresh control is preferably short.

Also, normally, in accordance with the refresh control, power output from the fuel cell continues to be wastefully consumed by being grounded and discharged until the liquid fuel that has already been supplied is consumed. Accordingly, from a perspective of energy conservation and improving efficiency of battery energy, recovering the power that is wastefully consumed during refresh control and adding the recovered power to power that is externally output from the fuel cell for use, is desirable.

The present disclosure provides a fuel cell system that achieves both stabilization of the power that is externally output and improvement of the efficiency of power utilization.

One aspect of the present disclosure is a fuel cell system including: a fuel cell having an electrode structure having an anode electrode and a cathode electrode, the anode electrode being supplied with a liquid fuel and also the cathode electrode being supplied with an oxidant to generate power; a first power storage device that is charged with a portion of power output from the fuel cell in a state in which supply of the liquid fuel to the fuel cell is being carried out; a second power storage device that, in a state in which supply of the liquid fuel to the fuel cell is stopped, is charged with and recovers post-stoppage power generated by the fuel cell using the liquid fuel that has already been supplied; a control device that controls supply of liquid fuel to the fuel cell and operations of the first power storage device and the second power storage device; a DC regulator circuit for stabilizing voltage, the DC regulator circuit being provided immediately before an external load and connected in parallel with the first power storage device; and a switch that is provided between the second power storage device and the DC regulator circuit, and that switches between supplying and interrupting power from the second power storage device to the external load via the DC regulator circuit. In the fuel cell system, the fuel cell is configured such that an electrode reaction in the electrode structure is stopped after the post-stoppage power is recovered by the second power storage device, out of the power output from the fuel cell, at least a portion of power besides the power to be charged to the first power storage device is supplied to the external load via the DC regulator circuit in a state in which supply of the liquid fuel to the fuel cell is being carried out, and under control of the control device, in a state in which supply of the liquid fuel to the fuel cell is stopped, power charged in the first power storage device is discharged and supplied to the external load, and in a state in which supply of the liquid fuel to the fuel cell is being carried out, the post-stoppage power recovered by the second power storage device is discharged and supplied to the external load via the DC regulator circuit by switching the switch to a state in which power is suppliable to the external load, in addition to power output from the fuel cell.

### Advantageous Effects

The fuel cell system according to the above aspect includes the first power storage device and the second power storage device. The first power storage device is charged with a portion of the power generated by the fuel cell in the state in which the supply of liquid fuel to the fuel cell is being carried out, and discharges the power charged in the first power storage device to the external load in the state in which the supply of liquid fuel to the fuel cell is stopped. Accordingly, even during refresh control in which the supply of liquid fuel to the fuel cell is stopped, the power supply to the external load can be maintained, and accordingly power that is externally output can be stabilized.

At the same time, the second power storage device is charged with and recovers the post-stoppage power generated by the fuel cell using the liquid fuel already supplied in the state in which the supply of liquid fuel to the fuel cell is stopped, and the electrode reaction of the fuel cell is stopped after the post-stoppage power is recovered by the second power storage device. Thereafter, the post-stoppage power recovered by the second power storage device is discharged to the external load, in addition to the power output from the fuel cell in the state in which supply of liquid fuel to the fuel cell is being carried out. Accordingly, the electrode reaction can be quickly stopped after the second power storage device recovers the post-stoppage power, thereby shortening the time during which power generation is stopped due to refresh control, and the post-stoppage power that conventionally was wastefully consumed can be recovered by the second power storage device and discharged to the external load for utilization. Thus, the efficiency of power usage can be improved.

As described above, according to this aspect, a fuel cell system that achieves both stabilization of power that is externally output and improvement of the efficiency of power utilization can be provided.

### BRIEF DESCRIPTION OF THE DRAWINGS

The foregoing and other objects, features, and advantages of the present disclosure will become more apparent from the following detailed description when taken in conjunction with the accompanying drawings, wherein:

FIG. 1 is a conceptual diagram illustrating a configuration of a fuel cell system according to Embodiment 1;

FIG. 2 is a conceptual diagram illustrating a configuration of a fuel cell according to Embodiment 1;

FIG. 3 is a conceptual diagram illustrating a configuration of a control device according to Embodiment 1;

FIG. 4 is a time chart for describing operations of the fuel cell system in a normal power generation mode according to Embodiment 1;

FIG. 5 is a time chart for describing operations of the fuel cell system in a refresh control mode according to Embodiment 1;

FIG. 6 is a time chart for describing operations of the fuel cell system in a receiving power storage device discharging mode according to Embodiment 1;

FIG. 7 is a time chart for describing operations of the fuel cell system in a normal-time power superimposing mode according to Embodiment 1;

FIG. 8 is a time chart for describing operations of the fuel cell system in a refresh-time power superimposing mode according to Embodiment 1;

FIG. 9 is a time chart for describing operations of the fuel cell system in another refresh-time power superimposing mode, according to Embodiment 1; and

FIG. 10 is a conceptual diagram illustrating a configuration of a control device according to Embodiment 2.

### MODES FOR CARRYING OUT

### Embodiment 1

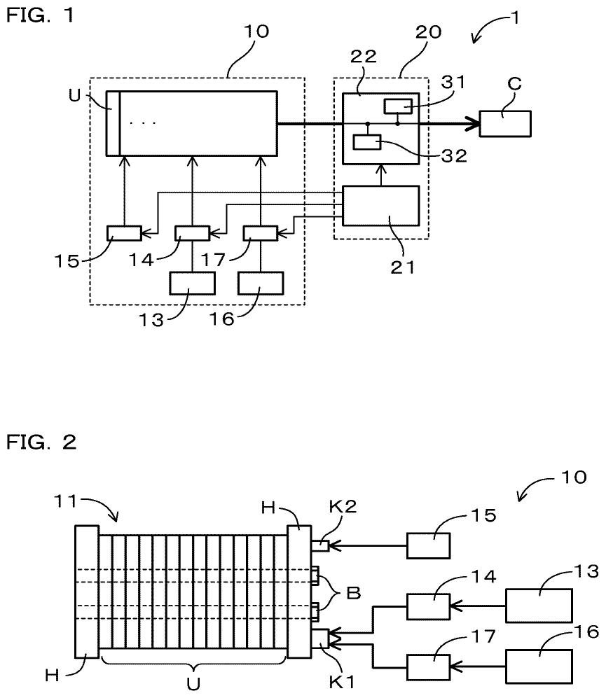

An embodiment of a fuel cell system will be described with reference to FIG. 1 to FIG. 9. As illustrated in FIG. 1, a fuel cell system 1 according to Embodiment 1 primarily includes a fuel cell 10, a control device 20, an auxiliary power source 31 serving as a first power storage device, and a receiving power storage device 32 serving as a second power storage device. Examples of a configuration of the fuel cell 10 include a fuel cell of a solid polymer type, although not limited thereto. In the fuel cell 10 of the solid polymer type, an anode electrode is formed on one face side of an electrolyte membrane, and a cathode electrode is formed on the other face side of the electrolyte membrane. Here, the electrolyte membrane, the anode electrode, and the cathode electrode make up an electrode structure called an MEA (Membrane-Electrode-Assembly). Note that the anode electrode and the cathode electrode are formed by performing coating with a metal catalyst such as, for example, platinum (Pt), palladium (Pd), or the like, carbon to which these metal catalysts have been added, and an electrolyte. Also, a fuel diffusion layer made of a conductor structure having a fuel supply structure is present between the MEA and the electrodes (fuel supply and electricity extraction structural members called separators in the case of multi-layer cells).

Examples of fuel supplied to the anode electrode of the fuel cell 10 of the solid polymer type include liquid fuels such as formic acid (HCOOH), methanol (CH₃OH), ethanol (C₂H₅OH), and so forth. In the present Embodiment 1, a case is exemplified in which the fuel cell 10 is a direct formic acid fuel cell (DFAFC) that directly uses formic acid as liquid fuel. Also, examples of an oxidant (oxidant gas) supplied to the cathode electrode of the fuel cell 10 include oxygen (O₂) gas, air, and so forth. In the present Embodiment 1, a case in which air is used as the oxidant, i.e., the oxidant gas that is supplied to the fuel cell 10, will be described as an example.

As illustrated in FIG. 1, the fuel cell 10 of a solid polymer type according to the present Embodiment 1 includes a fuel cell stack 11. The fuel cell stack 11 is formed by stacking a plurality of unit cells U, each of which includes an MEA (omitted from illustration), an anode-side separator (omitted from illustration) that supplies liquid fuel to the anode electrode of the MEA, a cathode-side separator (omitted from illustration) that supplies an oxidant (oxidant gas) to the cathode electrode of the MEA, and a fuel diffusion layer (omitted from illustration).

As illustrated in FIG. 2, the fuel cell stack 11 is in a state in which the plurality of unit cells U are stacked together, and the plurality of unit cells U that are stacked are held in place by holders H and bolts B. In the fuel cell stack 11, a first pump 14 that pressurizes and supplies formic acid, which is the liquid fuel stored in a supply tank 13, is connected to a connection portion K1 via piping. Also, in the fuel cell stack 11, a blower 15 (pressurizing pump) that pressurizes and supplies air as the oxidant (oxidant gas) is connected to a connection portion K2 via piping. Further, a second pump 17 serving as a water supply device that pressurizes and supplies water stored in a supply tank 16 (e.g., produced water that is produced on the cathode side) is connected to the connection portion K1 via piping. As illustrated in FIG. 1, operations of the first pump 14, the blower 15, and the second pump 17 are controlled by the control device 20.

Now, the formic acid pressurized by the first pump 14 and the water (produced water) pressurized by the second pump 17 are supplied to the anode electrode via a switching valve (omitted from illustration). That is to say, in a case in which the fuel cell stack 11 is to generate power, formic acid is supplied to the anode electrode by switching the switching valve. In a case in which refresh control is to be performed, i.e., in a case in which an electrode reaction in the MEA is to be stopped, the supply of formic acid is stopped. The water (produced water) in the supply tank 16 is supplied to the anode electrode by switching the switching valve when adjusting concentration of the formic acid. Also, after the supply of formic acid is stopped during refresh control, inside of the fuel cell stack 11 may be cleansed by supplying water (produced water) from the supply tank 16 to the anode electrode by switching the switching valve. Note that the switching valve can be provided at the connection portion K1.

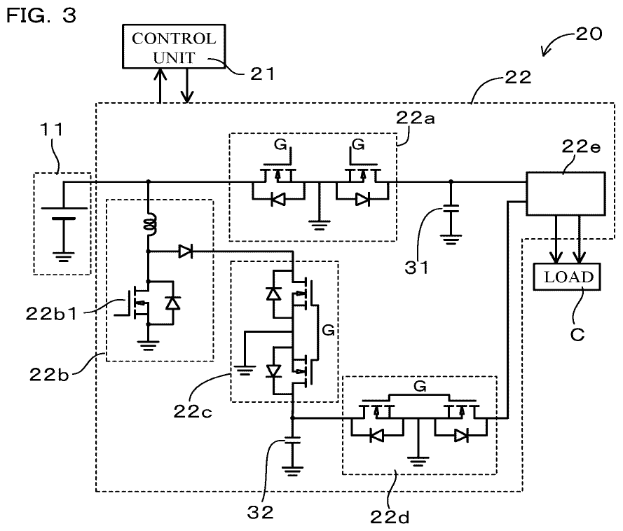

As illustrated in FIG. 1 and FIG. 3, the control device 20 primarily includes a control unit 21 and a control circuit 22. The control unit 21 is a microcomputer of which the primary components are a CPU, ROM, RAM, and an interface.

The control circuit 22 is an electrical circuit that is controlled by the control unit 21. The control circuit 22 electrically connects the fuel cell stack 11 and an external load C, as illustrated in FIG. 1. Also, the control circuit 22 electrically connects the fuel cell stack 11 and the auxiliary power source 31, and also electrically connects the auxiliary power source 31 and the external load C. Further, the control circuit 22 electrically connects the fuel cell stack 11 and the receiving power storage device 32, and also electrically connects the receiving power storage device 32 and the external load C.

Accordingly, under the control of the control unit 21, the control circuit 22 realizes each of the following states of a state in which the power generated by the fuel cell stack 11 is supplied to the external load C, a state in which the power generated by the fuel cell stack 11 is charged (stored) in the auxiliary power source 31, a state in which the power charged (stored) in the auxiliary power source 31 is supplied to the load C, a state in which post-stoppage power generated by the fuel cell stack 11 is charged (stored) in the receiving power storage device 32, and a state in which the power charged (stored) in the receiving power storage device 32 is supplied to the load C.

As illustrated in FIG. 3, the control circuit 22 primarily includes a first switch 22a, a boost circuit 22b, a second switch 22c, a third switch 22d, and a DC regulator circuit 22e. Operations thereof are controlled by the control unit 21. In the present embodiment, the control unit 21 is configured to control the operations of the fuel cell system by switching among a plurality of operation modes. These plurality of operation modes include a normal power generation mode in which power generated by the fuel cell 10 is supplied to the external load C and also charged (stored) in the auxiliary power source 31, a refresh control mode in which power generated by the fuel cell 10 (including post-stoppage power) is charged to the receiving power storage device 32 and also the power charged in the auxiliary power source 31 is supplied to the external load C, and a receiving power storage device discharging mode in which the power generated by the fuel cell 10 and the power charged in the receiving power storage device 32 are supplied to the external load C. Note that the above plurality of operation modes may include other operation modes, which will be described later.

As illustrated in FIG. 3, the first switch 22a is formed of two N-ch MOSFETs (N-channel MOSFETs) each having a parasitic diode, and is disposed between the fuel cell stack 11, and the DC regulator circuit 22e and auxiliary power source 31. The first switch 22a opens and closes by two N-ch MOSFETs being switched synchronously to an on state or an off state under the control of the control unit 21, thereby supplying or interrupting high-voltage power that is output from the fuel cell stack 11 to the DC regulator circuit 22e and the auxiliary power source 31. Note that the auxiliary power source 31 and the DC regulator circuit 22e are connected in parallel.

In the following description, in a case in which the two N-ch MOSFETs in the first switch 22a synchronously go to the on state, the first switch 22a is to be understood to be in the on state (closed state), and electricity is allowed to flow from the fuel cell stack 11 to the DC regulator circuit 22e and the auxiliary power source 31. On the other hand, in a case in which the two N-ch MOSFETs in the first switch 22a synchronously go to the off state, the first switch 22a is to be understood to be in the off state (open state), and electricity from the fuel cell stack 11 to the DC regulator circuit 22e and the auxiliary power source 31 is interrupted.

The boost circuit 22b may be any circuit capable of boosting input voltage, and, for example, a chopper circuit, a switching regulator, or a linear regulator, may be employed. In the present Embodiment 1, as illustrated in FIG. 3, the boost circuit 22b is configured as a boost chopper circuit that is made up of a choke coil, a capacitor, a diode, and a switch 22b1 that is made up of the N-ch MOSFETs. In the boost circuit 22b, the switch 22b1 is periodically and rapidly switched between the on state and the off state under the control of the control unit 21, thereby boosting the power (voltage) supplied from the fuel cell stack 11 and performing output thereof to the receiving power storage device 32.

Note that in the following description, in a case in which the switch 22b1 is in the on state or in a switching state (repeatedly in the on state and the off state), this is to be understood that the boost circuit 22b is in the on state. Also, in a case in which the switch 22b1 is in the off state, the boost circuit 22b is to be understood to be in the off state. Note that when the switch 22b1 is maintained in the on state, the power supplied from the fuel cell stack 11 is grounded via the switch 22b1 and discharged.

As illustrated in FIG. 3, the second switch 22c is formed of two N-ch MOSFETs, and is disposed between the boost circuit 22b and the receiving power storage device 32. The second switch 22c opens and closes by the two N-ch MOSFETs being switched synchronously to the on state or the off state under the control of the control unit 21, thereby supplying or interrupting the high-voltage power that is output from the boost circuit 22b to the receiving power storage device 32.

Note that in the following description, in a case in which the two N-ch MOSFETs in the second switch 22c synchronously go to the on state, the second switch 22c is to be understood to be in the on state (closed state), and electricity is allowed to flow from the boost circuit 22b to the receiving power storage device 32. Also, in a case in which the two N-ch MOSFETs in the second switch 22c synchronously go to the off state, the second switch 22c is to be understood to be in the off state (open state), and electricity from the boost circuit 22b to the receiving power storage device 32 is interrupted.

As illustrated in FIG. 3, the third switch 22d is formed of two N-ch MOSFETs, and is disposed between the receiving power storage device 32 and the DC regulator circuit 22e. The third switch 22d opens and closes by the two N-ch MOSFETs being switched synchronously to the on state or the off state under the control of the control unit 21, thereby supplying or interrupting the power output from the receiving power storage device 32 to the DC regulator circuit 22e.

Note that in the following description, in a case in which the two N-ch MOSFETs in the third switch 22d synchronously go to the on state, the third switch 22d is to be understood to be in the on state (closed state), and electricity is allowed to flow from the receiving power storage device 32 to the DC regulator circuit 22e. Also, in a case in which the two N-ch MOSFETs in the third switch 22d synchronously go to the off state, the third switch 22d is to be understood to be in the off state (open state), and electricity from the receiving power storage device 32 to the DC regulator circuit 22e is interrupted.

As described above, a configuration in which two N-ch MOSFETs are synchronized to open and close a circuit is employed for each of the first switch 22a, the second switch 22c and the third switch 22d, but this is not restrictive, and it is sufficient for each switch to be configured so as to be capable of switching control between conducting and interrupting electricity.

The DC regulator circuit 22e illustrated in FIG. 3 is a well-known so-called switching regulator, and is a circuit that stabilizes the power (voltage) supplied from the fuel cell stack 11, the auxiliary power source 31, and the receiving power storage device 32. Note that in the following description, in a case in which a switch, omitted from illustration, in the DC regulator circuit 22e goes to the on state, the DC regulator circuit 22e is to be understood to be in the on state, and in a case in which this switch, omitted from illustration, goes to the off state, the DC regulator circuit 22e is to be understood to be in the off state. The DC regulator circuit 22e has a plurality of output channels, and may have, for example, a 12 V output channel for supplying power to the external load C, and a 5 V output channel for control. Note that voltage level output from each output channel may be variable.

The auxiliary power source 31 serving as the first power storage device illustrated in FIG. 3 may have any configuration as long as it is capable of charging/discharging power. Examples that can be employed as the auxiliary power source 31 include batteries such as a Li-ion battery, a NiH battery, a Na battery, a Pb battery, and so forth, and capacitors such as a Li-ion capacitor, an electric double-layer capacitor, and so forth. Note that a battery with a relatively large capacity is preferably employed as the auxiliary power source 31, so as to be capable of charging/discharging sufficient power. Note that the auxiliary power source 31 has a charge/discharge control circuit, omitted from illustration, for charging and discharging the auxiliary power source 31, and is capable of shifting (boosting) voltage level during discharging.

The auxiliary power source 31 is charged by (stores) a portion of the power generated by the fuel cell stack 11 in a case in which the first switch 22a provided in the control circuit 22 of the control device 20 illustrated in FIG. 3 is in the on state (closed state). Also, the auxiliary power source 31 discharges the charged (stored) high voltage power to the DC regulator circuit 22e by the first switch 22a provided in the control circuit 22 of the control device 20 being controlled to the off state (open state).

In the present Embodiment 1, in a case in which the fuel cell stack 11 is in the normal power generation mode in which the fuel cell stack 11 is generating power normally, the auxiliary power source 31 is charged by (stores) a portion of the power output from the fuel cell stack 11, which will be described later. Note that in a case in which the charge state of the auxiliary power source 31 reaches a predetermined state (e.g., a fully charged state), charging of the auxiliary power source 31 is stopped by the above charge/discharge control circuit that is omitted from illustration.

Also, in a case in which the fuel cell stack 11 is in the refresh control mode in which the supply of power from the fuel cell stack 11 to the DC regulator circuit 22e is stopped, the auxiliary power source 31 supplies power to the DC regulator circuit 22e by discharging the power charged in the auxiliary power source 31 to the DC regulator circuit 22e.

Also, in a case in which the voltage of the output power of the fuel cell stack 11 drops or in a case in which the external load C increases, the auxiliary power source 31 can discharge the power charged in the auxiliary power source 31 to the DC regulator circuit 22e, thereby superimposing the power thereof on the output power of the fuel cell stack 11 and performing supply of the power to the DC regulator circuit 22e.

The receiving power storage device 32 serving as the second storage device illustrated in FIG. 3 may have any configuration as long as the configuration is capable of charging/discharging power. Examples that can be employed as the receiving power storage device 32 include batteries such as a Li-ion battery, a NiH battery, a Na battery, a Pb battery, and so forth, and capacitors such as a Li-ion capacitor, an electric double-layer capacitor, and so forth. In particular, a capacitor is preferably employed as the receiving power storage device 32. Capacitors generally have low internal resistance, allowing for rapid charging when charging (storing) and also rapid discharging when discharging, and accordingly employing a capacitor as the receiving power storage device 32 enables charging/discharging responsivity of the receiving power storage device 32 to be improved. Note that the receiving power storage device 32 has a charge/discharge circuit, omitted from illustration, for charging/discharging the receiving power storage device 32, and is capable of shifting (boosting) voltage level during discharging.

The receiving power storage device 32 charges (stores) high-voltage power boosted by the boost circuit 22b provided in the control circuit 22 of the control device 20 in a case in which the second switch 22c provided in the control circuit 22 of the control device 20 is in the on state (closed state) and also the third switch 22d is in the off state (open state). Also, in a case in which the receiving power storage device 32 is charged (stores) up to a predetermined voltage, the third switch 22d provided in the control circuit 22 of the control device 20 is controlled to the on state (closed state), thereby discharging the charged (stored) high-voltage power to the DC regulator circuit 22e.

In a case in which the fuel cell stack 11 is in a refresh control mode in which the fuel cell stack 11 discharges power after supply of liquid fuel is stopped in accordance with refresh control, the receiving power storage device 32 is charged with (stores) at least a portion of the power discharged from the fuel cell stack 11 as post-stoppage power. Also, in a case of transitioning to the receiving power storage device discharging mode in a state in which the fuel cell stack 11 is generating power, the receiving power storage device 32 can discharge the power charged (stored) in the receiving power storage device 32 and perform supply thereof to the DC regulator circuit 22e.

Thus, the receiving power storage device 32 can recover at least a portion of post-stoppage power of the power discharged by the fuel cell stack 11, through refresh control by charging (storing) thereof. The receiving power storage device 32 can then supply the recovered post-stoppage power to the load C in addition to the power being generated by the fuel cell stack 11. This allows the receiving power storage device 32 to recover and reuse power.

Next, a form of operations of the fuel cell system 1 of the present Embodiment 1 will be described.

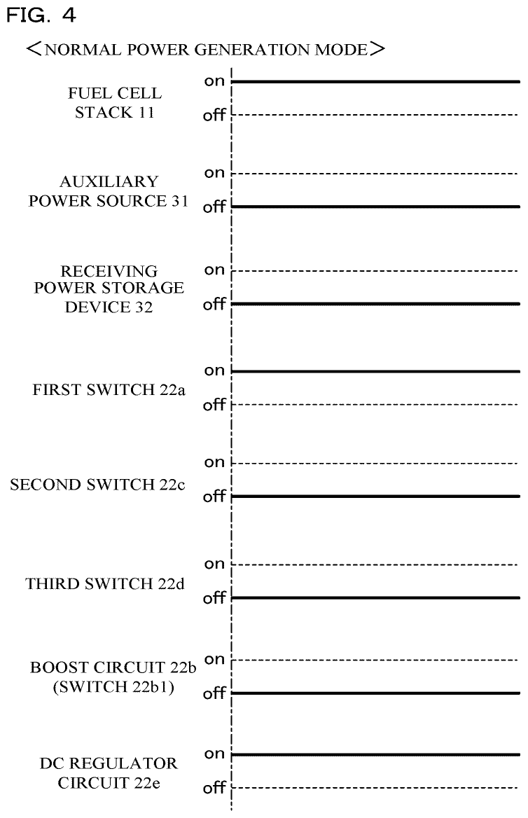

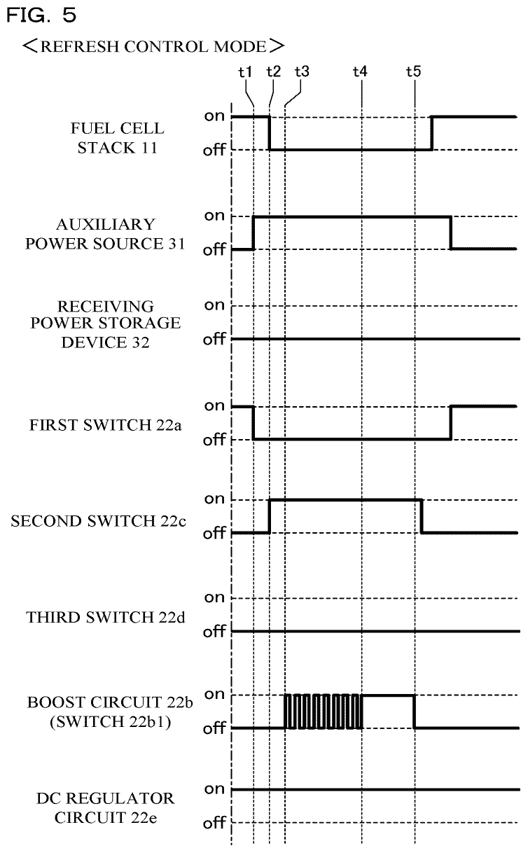

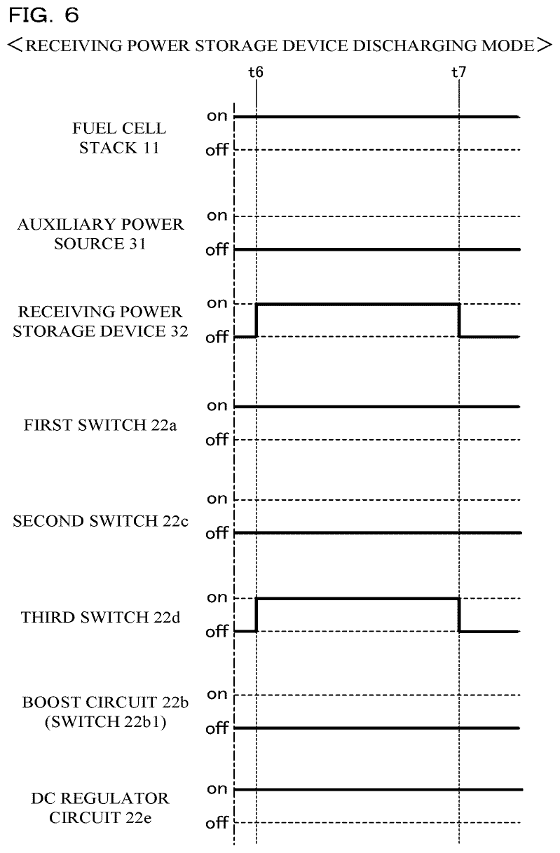

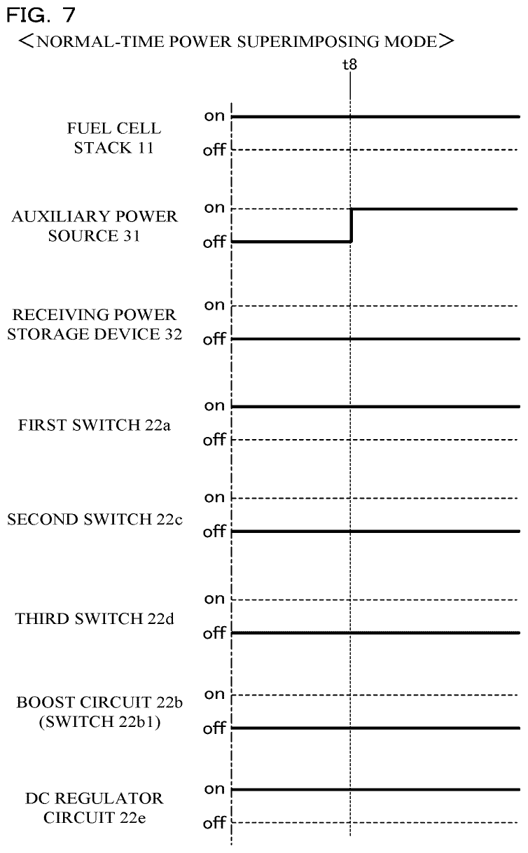

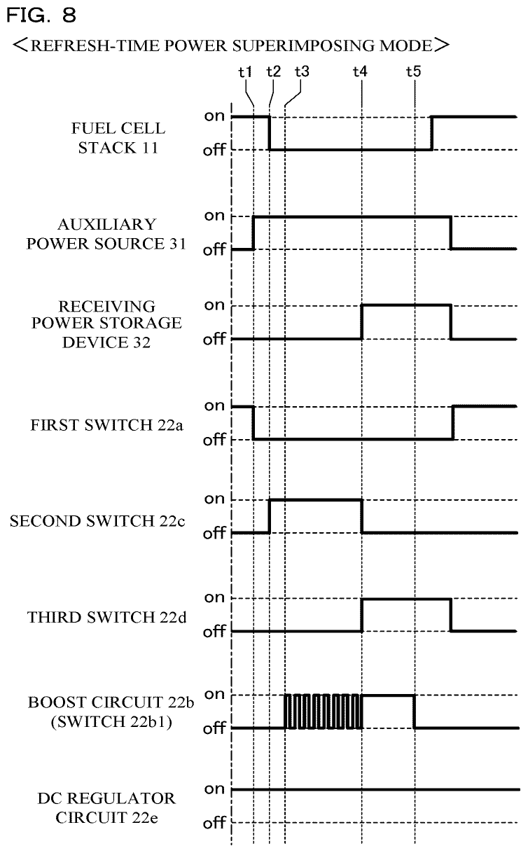

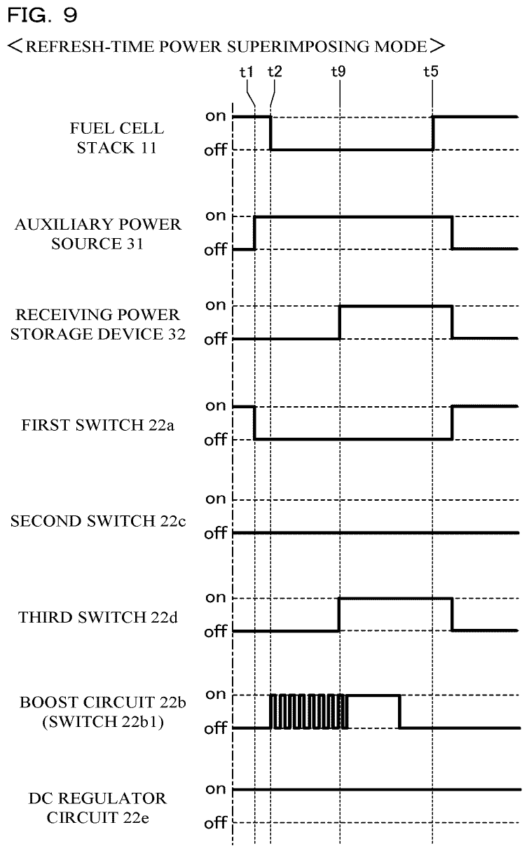

The fuel cell system 1 according to the present Embodiment 1 is configured to operate in each of the operation modes, which are the normal power generation mode shown in FIG. 4, the refresh control mode shown in FIG. 5, and the receiving power storage device discharging mode shown in FIG. 6, under the control of the control unit 21 in the control device 20. Also, in the present embodiment, the fuel cell system 1 is configured to operate in a normal-time power superimposing mode shown in FIG. 7 and a refresh-time power superimposing mode shown in FIGS. 8 and 9, as well. Each of the operation modes will be described below in order.

First, the normal power generation mode is an operation mode in which the power generated by the fuel cell stack 11 is output to the external load C, and also the auxiliary power source 31 is charged. In the normal power generation mode, as illustrated in FIG. 1, the control unit 21 of the control device 20 operates the first pump 14 to start supplying liquid fuel to the fuel cell 10, thereby turning the output of the fuel cell stack 11 to the on state as shown in FIG. 4, and also controls the outputs of the auxiliary power source 31 and the receiving power storage device 32 to the off state, turns the first switch 22a of the control circuit 22 to the on state, and controls the second switch 22c, the third switch 22d and the boost circuit 22b to the off state.

Thus, in the normal power generation mode, the power generated by the fuel cell stack 11 is supplied to the DC regulator circuit 22e and the auxiliary power source 31. The power supplied to the DC regulator circuit 22e is controlled to a predetermined voltage level by the DC regulator circuit 22e, and thereafter is output from a predetermined output channel and supplied to the external load C. On the other hand, the power supplied to the auxiliary power source 31 is charged to the auxiliary power source 31. Note that in a case in which the auxiliary power source 31 is in the fully charged state, no power is supplied to the auxiliary power source 31, and the auxiliary power source 31 is not charged.

Also, in the normal power generation mode, the second switch 22c is maintained in the off state, such that the power supply from the fuel cell stack 11 to the receiving power storage device 32 is interrupted. Further, the third switch 22d is maintained in the off state, and accordingly the power supply from the receiving power storage device 32 to the DC regulator circuit 22e is also interrupted.

Next, the refresh control mode shown in FIG. 5 is an operation mode in which refresh control of the fuel cell stack 11 in the fuel cell 10 is performed. The refresh control mode is started by transitioning from the normal power generation mode when a refresh control start timing t1 arrives in the normal power generation mode, as shown in FIG. 5. First, at the refresh control start timing t1, the control unit 21 of the control device 20 turns the output of the auxiliary power source 31 to the on state and also turns the first switch 22a to the off state.

Thereafter, when a fuel supply stop timing t2 arrives, the control unit 21 of the control device 20 stops the supply of liquid fuel to the fuel cell stack 11 by stopping the first pump 14, and also turns the second switch 22c to the on state. Thus, after the supply of liquid fuel (formic acid) by the first pump 14 is stopped, and the post-stoppage power, generated in the fuel cell stack 11 by the liquid fuel that was supplied to the fuel cell stack 11 before stopping, is supplied to the boost circuit 22b. Note that the third switch 22d is kept in the off state.

Then, as shown in FIG. 5, when a boost start timing t3 arrives, the control unit 21 of the control device 20 turns the boost circuit 22b to the on state, and rapidly switches on and off the switch 22b1 to perform boost switching control. Accordingly, the post-stoppage power supplied to the boost circuit 22b is boosted to a predetermined voltage by the boost circuit 22b and is supplied to the receiving power storage device 32. Note that the refresh control start timing t1, the fuel supply stop timing t2, and the boost start timing t3 may arrive simultaneously.

Thereafter, as shown in FIG. 5, when a charging end timing t4 for the receiving power storage device 32 arrives, the switch 22b1 of the boost circuit 22b is maintained in the on state. The charging end timing t4 can be set to a timing at which the post-stoppage power decreases, and charging to the receiving power storage device 32 is no longer performable. Maintaining the switch 22b1 of the boost circuit 22b in the on state then ends the boosting by the boost circuit 22b, and also the post-stoppage power is discharged until the post-stoppage power reaches approximately 0 V, which is reference potential.

When a refresh control end timing t5 arrives, the control unit 21 of the control device 20 maintains the switch 22b1 of the boost circuit 22b in the off state. Then, after turning the second switch 22c to the off state, the control unit 21 drives the first pump 14 to resume the supply of liquid fuel to the fuel cell stack 11. Thereafter, the control unit 21 turns the first switch 22a to the on state, and also stops the output of the auxiliary power source 31. This ends the refresh control mode.

In this refresh control mode, after the fuel cell stack 11 is controlled to stop generating power, i.e., after supply of liquid fuel (formic acid) is stopped, at least a portion of the post-stoppage power generated using the liquid fuel that was supplied to the fuel cell stack 11 before the supply was stopped is boosted and charged (stored) in the receiving power storage device 32, and thereby recovered. Note that in the refresh control mode, the third switch 22d is maintained in the off state, such that the power supply from the receiving power storage device 32 to the DC regulator circuit 22e is interrupted.

Next, the receiving power storage device discharging mode shown in FIG. 6 is an operation mode in which the power charged (stored) in the receiving power storage device 32 is output to the external load C along with the power generated by the fuel cell stack 11. In the receiving power storage device discharging mode, as shown in FIG. 6, when a discharge start timing t6 arrives, the control unit 21 of the control device 20 turns the third switch 22d to the on state, and turns the output of the receiving power storage device 32 to the on state. Accordingly, the power charged (stored) in the receiving power storage device 32 is output to the external load C via the DC regulator circuit 22e.

Note that a configuration is made such that the power output from the receiving power storage device 32 is boosted to a voltage no lower than equivalent to the power output from the fuel cell stack 11 by a charge/discharge control circuit, omitted from illustration, that is provided in the receiving power storage device 32. This allows the power output from the receiving power storage device 32 to be consumed with priority.

Note that in the receiving power storage device discharging mode, as shown in FIG. 6, the first switch 22a is maintained in the on state, and the second switch 22c and the boost circuit 22b are maintained in the off state. Thus, at least a portion of the post-stoppage power generated by the refresh control is not discarded but is charged to the receiving power storage device 32, and thereafter discharged from the receiving power storage device 32 and output to the external load C.

As shown in FIG. 6, when a discharge end timing t7 arrives, at which the output voltage of the power that is charged (stored) in the receiving power storage device 32 is no greater than a predetermined value, the control unit 21 of the control device 20 turns the third switch 22d to the off state, thereby turning the output of the receiving power storage device 32 to the off state. This allows the receiving power storage device discharging mode to end, and to transition to the normal power generation mode shown in FIG. 5. In the fuel cell system 1 according to Embodiment 1, the output from the DC regulator circuit 22e is maintained in the on state throughout each of the above operation modes.

Note that in the present Embodiment 1, in a case in which power is stored in the auxiliary power source 31, the operation mode of the fuel cell system 1 can be set to the normal-time power superimposing mode shown in FIG. 7. The normal-time power superimposing mode is an operation mode in which the power stored in the auxiliary power source 31 is superimposed on the power supplied from the fuel cell stack 11 to the DC regulator circuit 22e.

For example, in the normal-time power superimposing mode, at a timing t8 shown in FIG. 7, in a case in which an output current value in the 12 V channel of the DC regulator circuit 22e increases and reaches or exceeds a predetermined current value, or in a case in which the power from the fuel cell stack 11 falls below a predetermined reference value, the control circuit 22 turns the output of the auxiliary power source 31 to the on state, causing the power stored in the auxiliary power source 31 to be discharged, and this power is superimposed on the power from the fuel cell stack 11 and supplied to the DC regulator circuit 22e. This enables further stabilization of the power source output.

Note that in the present Embodiment 1, the first switch 22a is made up of N-ch MOSFETs having parasitic diodes being connected in series, such that even in a case in which the power of the auxiliary power source 31 is superimposed on the power from the fuel cell stack 11 as described above, the power of the auxiliary power source 31 is prevented from being transmitted to the fuel cell stack 11 via the first switch 22a.

Note that in the present Embodiment 1, as described above, the power charged to the receiving power storage device 32 is discharged in the receiving power storage device discharging mode shown in FIG. 6 and output to the external load C, but the timing for discharging the power charged to the receiving power storage device 32 is not limited to this. For example, in a case in which the auxiliary power source 31 deteriorates or the like and the power output from the auxiliary power source 31 falls below a predetermined reference value, or in a case in which the output current value in the 12 V channel of the DC regulator circuit 22e increases during refresh control and reaches or exceeds a predetermined current value, the power output can conceivably be stabilized by discharging the power charged in the receiving power storage device 32 during refresh control, and performing output thereof to the external load C.

Examples of such operation modes in which the receiving power storage device 32 is discharged during the refresh control are shown in FIG. 8 and FIG. 9. First, in the refresh-time power superimposing mode shown in FIG. 8, during refresh control, at the point in time at which the charging end timing t4 for ending charging to the receiving power storage device 32 arrives, the switch 22b1 of the boost circuit 22b is maintained in the on state and the charging to the receiving power storage device 32 ends, and also the second switch 22c is turned to the off state and the third switch 22d is turned to the on state, to discharge the charged power in the receiving power storage device 32, which is then superimposed on the power from the auxiliary power source 31 and supplied to the DC regulator circuit 22e. This enables stabilization of the power output during refresh control in a case in which the power output from the auxiliary power source 31 falls below a predetermined reference value or in a case in which the output current value in the 12 V channel of the DC regulator circuit 22e increases during refresh control and reaches or exceeds a predetermined current value, as well.

Thereafter, as shown in FIG. 8, when the refresh control end timing t5 arrives, the switch 22b1 of the boost circuit 22b is maintained in the off state, and the supply of liquid fuel to the fuel cell stack 11 is resumed by driving the first pump 14 by the control unit 21, after which the first switch 22a is turned to the on state and the output of the auxiliary power source 31 is stopped, and the third switch 22d is turned to the off state and the output of the receiving power storage device 32 is stopped, whereby the refresh control can be ended.

Also, in a case in which the power output from the auxiliary power source 31 has decreased due to deterioration of the auxiliary power source 31 or the like, and it is predicted in advance that the power of the auxiliary power source 31 will be insufficient at the time of the next refresh control, the refresh-time power superimposing mode shown in FIG. 9 can be employed. In the refresh-time power superimposing mode shown in FIG. 9, during refresh control, the second switch 22c is kept in the off state, and after the fuel supply stop timing t2, the switch 22b1 is switched on and off rapidly and thereafter maintained in the on state, thereby performing grounding thereof until the post-stoppage power reaches approximately 0 V, thereby discharging the post-stoppage power. Thus, the post-stoppage power is not charged to the receiving power storage device 32. Note that alternatively or in addition to this, the second switch 22c may be kept in the off state, and the switching valve may be switched to supply water (produced water) from the supply tank 16 to the anode electrode, thereby cleansing the inside of the fuel cell stack 11 and quickly stopping the electrode reaction.

Then, at a timing t9 shown in FIG. 9, in a case in which the power from the auxiliary power source 31 falls below a predetermined reference value, the control circuit 22 turns the output of the receiving power storage device 32 to the on state and also turns the third switch 22d the one state, so as to discharge the power stored in the receiving power storage device 32, and performs superimposing thereof on the power from the auxiliary power source 31, so as to be supplied to the DC regulator circuit 22e. Thus, while recovery of post-stoppage power is not performed in the refresh control this time, the power source output can be stabilized in the refresh control this time instead. Note that thereafter, as shown in FIG. 9, when the refresh control end timing t5 arrives, the control unit 21 drives the first pump 14 to resume the supply of liquid fuel to the fuel cell stack 11, after which the first switch 22a is turned to the on state and also the output of the auxiliary power source 31 is stopped, and the third switch 22d is turned to the off state and also the output of the receiving power storage device 32 is stopped, whereby the refresh control can be ended.

Next, operational effects of the fuel cell system 1 according to the present embodiment will be described in detail.

The fuel cell system 1 of the present embodiment includes the auxiliary power source 31 serving as the first power storage device, and the receiving power storage device 32 serving as the second power storage device. The auxiliary power source 31 is charged with a portion of the power generated by the fuel cell 10 in a state in which the supply of liquid fuel to the fuel cell 10 is being carried out, and discharges the power charged in the auxiliary power source 31 to the external load C in a state in which the supply of liquid fuel to the fuel cell 10 is stopped. Thus, even during refresh control in which the supply of liquid fuel to the fuel cell 10 is stopped, the power supply to the external load C can be maintained, thereby stabilizing the external output of power.

At the same time, the receiving power storage device 32 is charged with and recovers the post-stoppage power generated by the fuel cell 10 using the liquid fuel that has already been supplied in a state in which the supply of liquid fuel to the fuel cell 10 is stopped, and the electrode reaction of the fuel cell 10 is stopped after the post-stoppage power is recovered by the receiving power storage device 32. Thereafter, the post-stoppage power recovered by the receiving power storage device 32 is discharged to the external load C, in addition to the power output from the fuel cell 10 in the state in which supply of liquid fuel to the fuel cell 10 is being carried out. Accordingly, the electrode reaction can be quickly stopped after the receiving power storage device 32 recovers the post-stoppage power, thereby shortening the time during which power generation is stopped due to refresh control, and also, post-stoppage power that conventionally was wastefully consumed can be recovered by the receiving power storage device 32 and discharged to the external load C for utilization. Thus, the efficiency of power usage can be improved.

Also, in the present Embodiment 1, the boost circuit 22b is provided that boosts the post-stoppage power that is charged to the receiving power storage device 32 serving as the second storage device. This enables a greater amount of post-stoppage power to be charged to the receiving power storage device 32, thereby further improving the efficiency of power utilization.

Also, in the present Embodiment 1, the control device 20 is configured to control the operations of the fuel cell system 1 by switching among the plurality of operation modes. The plurality of operation modes include the normal power generation mode, the refresh control mode, and the second power storage device discharging mode (i.e., the receiving power storage device discharging mode). This normal power generation mode is set to supply at least a portion of the power generated by the fuel cell 10 to the external load C, and also to charge a portion of the power generated by the fuel cell 10 to the auxiliary power source 31 serving as the first power storage device. Also, the refresh control mode is set so as to stop the supply of liquid fuel to the fuel cell 10 for refresh control of the fuel cell 10, charge at least a portion of the post-stoppage power to the receiving power storage device 32 serving as the second storage device, and supply the power charged to the auxiliary power source 31 to the external load C.

The receiving power storage device discharging mode is set such that at least a portion of the power generated by the fuel cell 10 is supplied to the external load C, and also the power charged in the receiving power storage device 32 is supplied to the external load C. In the present Embodiment 1, having such a configuration enables performing refresh control of the fuel cell 10 without stopping the supply of power to the external load C, and also smoothly recovering post-stoppage power to be used to supply power to the external load C, by switching among the normal power generation mode, the refresh control mode, and the receiving power storage device discharging mode. Accordingly, both stabilization of the power supplied to the external load C, and improving the efficiency of power utilization, can be realized even further.

In the present Embodiment 1, the above plurality of operation modes further include a power superimposing supply mode that is set to supply the power generated by the fuel cell 10 and the power charged to the first power storage device 31 to the external load C. Thus, in a case in which the output current value increases and reaches or exceeds a predetermined current value, or in a case in which the power from the fuel cell stack 11 falls below a predetermined reference value, the power stored in the auxiliary power source 31 can be discharged by the control circuit 22 and superimposed on the power from the fuel cell stack 11, and supplied to the DC regulator circuit 22e, whereby further stabilization of the power output can be realized.

As described above, according to this aspect, the fuel cell system 1 that achieves both stabilization of power that is externally output and improvement of the efficiency of power utilization can be provided.

### Embodiment 2

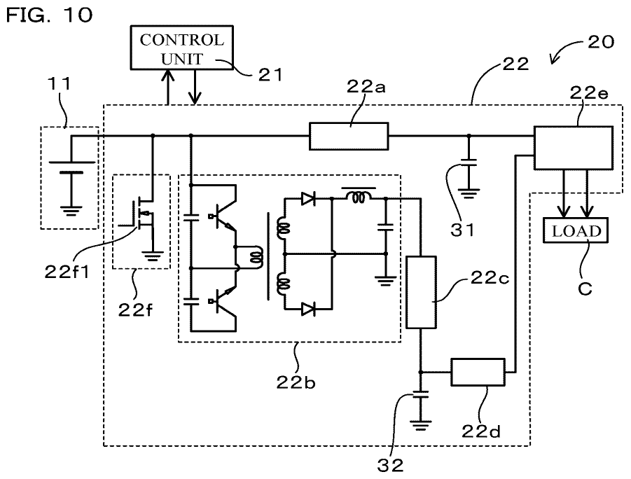

In the above-described Embodiment 1, a boost chopper circuit is employed as the boost circuit 22b, as illustrated in FIG. 3, but, in the present Embodiment 2 illustrated in FIG. 10, the boost circuit 22b is instead made up of a switching regulator that converts a direct current into alternating current, thereafter boosts the alternating current using a transformer, and performs reconverting thereof into direct current again. Also, in the above-described Embodiment 1, when the charging end timing t4 of charging to the receiving power storage device 32 arrives as shown in FIG. 5, the switch 22b1 of the boost circuit 22b is maintained in the on state, such that the post-stoppage power is grounded and discharged until becoming approximately 0 V.

In the present Embodiment 2, instead of this, a discharging unit 22f that includes a switch 22f1 made up of an N-ch MOSFET is connected in parallel between the fuel cell stack 11 and the boost circuit 22b. The control circuit 22 then turns the switch 22f1 of the discharging unit 22f to the on state (i.e., in a state capable of conducting electricity), thereby discharging the post-stoppage power until reaching the reference potential of approximately 0 V when the charging end timing t4 for the receiving power storage device 32 arrives. Note that in other states, the discharging unit 22f is placed in the off state (i.e., a state in which electricity is interrupted) by the control circuit 22.

Note that other configurations in the present Embodiment 2 that are the same configurations as those in Embodiment 1 are denoted by the same signs, and description thereof is omitted. Also, in FIG. 7, the switches 22a, 22c, and 22d have the same configuration as in those in the case of Embodiment 1, and illustration thereof is simplified.

In the present Embodiment 2, a switching regulator using a transformer is used as the boost circuit 22b, and accordingly the power conversion efficiency and the responsivity of power conversion can be improved, and power utilization efficiency can be further improved. Note that the present Embodiment 2 also provides the same operational effects as in the case of the above-described Embodiment 1.

Note that as described above, in Embodiment 1, a boost chopper circuit is employed as the boost circuit 22b, and in the Embodiment 2, a boost transformer circuit is employed, but instead of these, a boost/buck chopper circuit can also be employed. In this case as well, the same operational effects as those in the Embodiments 1 and 2 described above are provided.

Moreover, instead of the boost circuit 22b in Embodiments 1 and 2, a buck circuit for stepping down the input voltage may be used. A known configuration can be employed for the buck circuit, such as a boost/buck chopper circuit, a buck chopper circuit, or the like. In a case of using this buck circuit, the peak current can be reduced to protect the circuit in a case in which the power output from the fuel cell stack 11 has an excessively high peak current.

Although the present disclosure has been described based on the embodiments, it should be understood that the present disclosure is not limited to such embodiments or structures. The present disclosure also includes various modified forms, and modifications within a scope of equivalency. In addition, various combinations and forms, and further other combinations and forms including these and just one element, or more elements, or fewer elements, are also encompassed within the spirit and scope of the present disclosure.

1. A fuel cell system, comprising:
a fuel cell having an electrode structure having an anode electrode and a cathode electrode, the anode electrode being supplied with a liquid fuel and also the cathode electrode being supplied with an oxidant to generate power;
a first power storage device that is charged with a portion of power output from the fuel cell in a state in which supply of the liquid fuel to the fuel cell is being carried out;
a second power storage device that, in a state in which supply of the liquid fuel to the fuel cell is stopped, is charged with and recovers post-stoppage power generated by the fuel cell using the liquid fuel that has already been supplied; and
a control device that controls supply of liquid fuel to the fuel cell and operations of the first power storage device and the second power storage device;
a DC regulator circuit for stabilizing voltage, the DC regulator circuit being provided immediately before an external load and connected in parallel with the first power storage device; and
a switch that is provided between the second power storage device and the DC regulator circuit, and that switches between supplying and interrupting power from the second power storage device to the external load via the DC regulator circuit, wherein
the fuel cell is configured such that an electrode reaction in the electrode structure is stopped after the post-stoppage power is recovered by the second power storage device,
out of the power output from the fuel cell, at least a portion of power besides the power to be charged to the first power storage device is supplied to the external load via the DC regulator circuit in a state in which supply of the liquid fuel to the fuel cell is being carried out, and
under control of the control device,
in a state in which supply of the liquid fuel to the fuel cell is stopped, power charged in the first power storage device is discharged and supplied to an external load, and
in a state in which supply of the liquid fuel to the fuel cell is being carried out, the post-stoppage power recovered by the second power storage device is discharged and supplied to the external load via the DC regulator circuit by switching the switch to a state in which power is suppliable to the external load, in addition to power output from the fuel cell.

2. The fuel cell system according to claim 1, further comprising a boost circuit for boosting the post-stoppage power charged to the second power storage device.

3. The fuel cell system according to claim 1, wherein the control device is configured to control operation of the fuel cell system by switching among a plurality of operation modes, the plurality of operation modes including
a normal power generation mode that is set such that at least a portion of power generated by the fuel cell is supplied to the external load, and also a portion of the power generated by the fuel cell is charged to the first power storage device,
a refresh control mode that is set such that supply of the liquid fuel to the fuel cell is stopped to perform refresh control of the fuel cell, and also at least a portion of the post-stoppage power is charged to the second power storage device and the power charged in the first power storage device is supplied to the external load, and
a second power storage device discharging mode that is set such that at least a portion of the power generated by the fuel cell is supplied to the external load, and also the power charged in the second power storage device is supplied to the external load.

4. The fuel cell system according to claim 3, wherein the plurality of operation modes further includes a normal-time power superimposing supply mode that is set to supply the power generated by the fuel cell and the power charged in the first power storage device to the external load.
